(19) United States
(12) Patent Application Publication
(10) Pub. No.: US 2009/0133421 A1
(43) Pub. Date: May 28, 2009

(54) COOLING ELEMENT FOR COOLING OF PRODUCTS SUCH AS FOODSTUFFS, METHOD FOR PRODUCING A COOLING ELEMENT AND SYSTEM FOR COOLING

(76) Inventors: Robert Sylwander, Akersberga (SE); Johan Bergqvist, Stockholm (SE); Rickard Gustavsson, Upplands Vasby (SE)

Correspondence Address: DICKSTEIN SHAPIRO LLP, 1825 EYE STREET NW, Washington, DC, 20006-5403, US

(21) Appl. No.: 12/095,496

(22) PCT Filed: Nov. 30, 2005
(86) PCT No.: PCT/SE05/01799

§ 371 Date: Oct. 9, 2008

(51) Int. Cl. F25D 23/00; B23P 15/26

(52) U.S. Cl. 62/259.1; 29/890.035

(57) ABSTRACT

A cooling element (1) for cooling of products such as foodstuffs, said cooling element having essentially panel shape with a cooling side (2), a backside (3), a pair of transversal edge sides (4,4′) and a pair of longitudinal edge sides (5,5′), and having an inlet (9) and an outlet (8) for cooling medium to be transmitted through cooling channel means (20), is distinguished by the cooling element (1) being provided with means (6,7), for fastening it together with another similar cooling element (1′) at least on one transversal edge side. The invention also relates to a method for the production of a cooling element and a system for cooling.

### FIELD OF THE INVENTION

The invention is related to a cooling element according to the preamble of claim 1, it also concerns a method for producing a cooling element and a system for cooling.

### BACKGROUND OF THE INVENTION

Cooling elements for supporting, displaying and at the same time cooling perishable foodstuffs such as fruit and vegetables are commonly used in large as well as small grocery stores.

The previously known cooling elements are typically tailor-made for the specific use and are therefore adapted to the size of the display area. This often leads to very large, heavy and cumbersome cooling elements that are difficult to handle and to mount at the intended position.

FR 2533375 describes cooling plates for displaying perishable foodstuffs on markets and the like. If a larger display area is necessary, it is possible to series-connect a number of cooling plates with each other by connecting hoses into coupling parts positioned on an underside of the cooling plates. The known plates are, however, not easily installed and the fluid connections between two plates risk being compromised.

### AIM AND MOST IMPORTANT FEATURES OF THE INVENTION

It is an aim of the invention to provide a cooling element as initially defined which overcome the problems of the background art and to present a readily handled cooling element that allows an easy installation.

These aims are obtained according to a first aspect of the invention through the features of the characterizing portion of claim 1. Hereby modular construction of cooling elements in counters for perishable foodstuffs is made possible, to the extent that the modules are fixed to one another and thereby the aspect of mutual stability between adjacent elements is fulfilled. That stability aspect is also important since it reduces requirements on supporting structures for the elements. It also reduces the risk for strain on conduits for cooling medium to be connected to the elements.

By the means for fastening being controllable so that they can be manipulated from the cooling side, installation and mounting is simplified in that an operator in the process of connecting two cooling elements can easily attend to the fastening procedure without needing to have access to the backside of the elements.

When the inlet and the outlet for cooling medium is positioned in or close to a transversal edge side, it allows easy interconnection of the cooling channel means of two neighbouring cooling elements, preferably by a sliding or a pivoting relative movement between the cooling elements. Hereby it is possible to arrange the means for fastening and the inlets/outlets for cooling medium such that the cooling circuits of both elements are interconnected prior to or in connection with fastening the elements together. Easy and secure installation is obtained by these measures.

It is preferred that the inlet leads to a distribution channel for distributing cooling medium to the cooling channel means. The latter preferably including a plurality of parallel conduits that are parallel-fed with cooling medium from said distribution channel. When the distribution channel connects to said parallel conduits over a cut-out or cut-outs in an element or elements forming the cooling channel means, a simply manufactured solution is provided that is easily produced.

It is preferred that the flow resistance in said parallel conduits is balanced to the total flow of cooling medium in such a way that all parallel conduits are effective for cooling medium transport. This is easily achieved by simple testing by one skilled in the art and concerns i.a. dimensioning of the cooling channel means.

In particular it is highly preferred that the distribution channel has its intake for cooling medium, coming from the inlet to the cooling element, in a position close to a longitudinal side of the cooling element which is intended to be in a top position in operation of the device. This arrangement ensures that possible air in any of the parallel conduits, in particular at upstart of the device, is effectively flushed away by flowing cooling medium so as not to be trapped inside a cooling element, which could otherwise lead to inferior cooling effect of the cooling element.

According to a second aspect of the invention corresponding to the characterizing features of claim 19, the cooling channel means includes a plurality of parallel conduits extending side by side from one edge side of the cooling element to the other. Hereby effective heat transfer is ensured. In particular, this effect is enhanced when the conduits are formed in one integral constructional unit. This latter feature also provides for economic and easy production of the inventive cooling element, since a minimum of parts have to be assembled at manufacture.

Most-preferred said constructional unit is made from a channelled board, and particularly of plastics material which is a relatively inexpensive standard product allowing good production economy as well as good heat transfer and good flow resistance properties.

The same advantages are achieved through the features of the claims depending on claim 19 as through the features of the corresponding dependent claims depending on claim 1 and that are described in connection with that claim.

It is preferred that the cooling channel means is divided such that one half of the cooling channel means is connected to a first inlet for cooling medium at a first transversal edge side of the cooling element and to a first outlet for cooling medium at a second transversal edge side. The second half of the cooling channel means included in the cooling element is connected to a second inlet for cooling medium positioned in the second transversal edge side and finally the second cooling channel means is connected to a second outlet for cooling medium being positioned in the first transversal edge side. The inlet and outlet on the second transversal edge side may either be interconnected with each other so as to form a direct connection between the first and the second cooling channel means parts of the cooling element or be connected to an inlet and an outlet on a first transversal edge side of a second cooling element that is fastened to the first cooling element.

According to a third aspect of the invention corresponding to the characterizing features of claim 26, an easily and economically advantageous produced cooling plate is defined. Further, it is possible to produce the cooling plate light-weight, which is a great advantage in connection with transport and handling. Preferably, the panel halves are made of aluminium or an alloy thereof in order to enhance light-weight and economy.

The corresponding advantages are obtained through the features of the method claim 49.

The same advantages are achieved through the features of the claims depending on claim 26 as through the features of the corresponding dependent claims depending on claim 1 and 19 and that are described in connection with these claims.

The remaining claims define further inventive features that are described below with reference to embodiments.

### BRIEF DESCRIPTION OF DRAWINGS

The invention will now be described in greater detail with reference to the drawings, wherein:

FIG. 1 shows two interconnected cooling elements according to the invention in a perspective view.

FIG. 2 shows elements corresponding to the ones in FIG. 1 turned up-side-down with one of the elements having parts removed for clarity.

FIG. 3 shows a detail of a cooling element according to the invention.

FIG. 4 shows another detail of a cooling element according to the invention.

FIGS. 5a and b show details of a cooling element according to the invention.

FIGS. 6a and 6b show other principles of connecting two cooling elements.

FIG. 7 shows a section through a cooling element.

FIG. 8 indicates a sequence of a method for the production of a cooling element.

FIG. 9 indicates a method of sealing a channelled board.

### DESCRIPTION OF EMBODIMENT

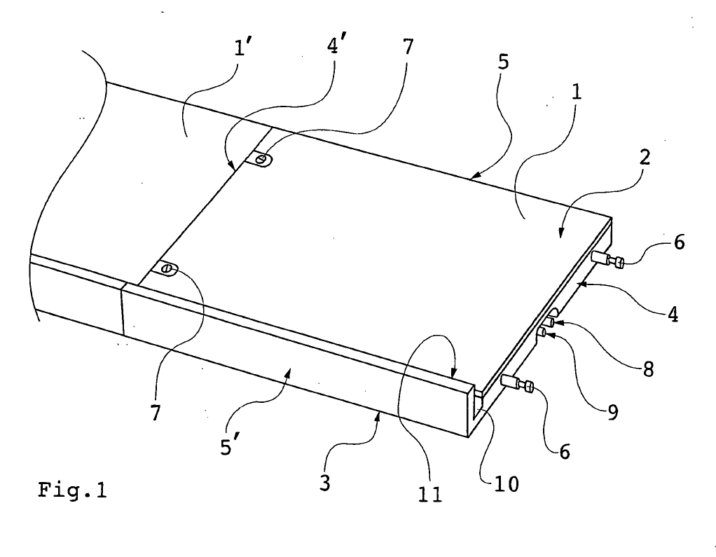

In FIG. 1 is shown a first cooling element 1 which is mechanically fastened to a second cooling element 1′ (shown in part). The cooling element 1 has a cooling side 2, which is an upper side in operation of the device, a backside 3, a first transversal edge side 4 and a second transversal edge side indicated with 4′. Further, a first longitudinal edge side 5 and a second longitudinal edge side 5′.

It should be noted that the terms “transversal” and “longitudinal” in this text has no reference to the dimensional extensions of the cooling element. The longitudinal edge sides could very well be shorter than the transversal edge sides. Further, it is not excluded that the cooling side is directed sideways or even downwards in very specific applications.

On the first transversal edge side 4 there are provided two fastening elements 6 that are extending in a longitudinal direction of the cooling element. These fastening elements 6 are intended to co-operate with fixing devices 7, being provided at a meeting transversal edge side region of another cooling element that is intended to be fastened to the cooling element 1. This way a cooling element 1 according to the invention on one transversal edge side 4 is provided with fastening elements 6 and on the second transversal edge side 4 with meeting fixing devices 7 such as rotatable wedge elements, which are well known for connecting parts of furniture items to one another.

The fixing devices 7 are manipulable from the upper side of the cooling element 1 which facilitates connecting the elements since no access is necessary from the backside.

In the area of the first transversal edge side 4 there are, positioned in a recess in the cooling element, from the bottom of said recess outwardly extending pipe portions extending also in a longitudinal direction of the cooling element. One of these pipe portions forms an inlet 9 for cooling medium and the other one forms an outlet 8 for cooling medium to be transmitted through the cooling element 1. In a region of the cooling element 1 which in use is intended to be in a lowest position, there is formed a collecting groove 10 for condensed water, leaking water etc. An edge strip 11 delimits this collecting groove 10, said edge strip extending above a general plane of the cooling side 2 whereby boxes etc. containing foodstuffs and resting against the edge strip are prevented from slipping away from the cooling element.

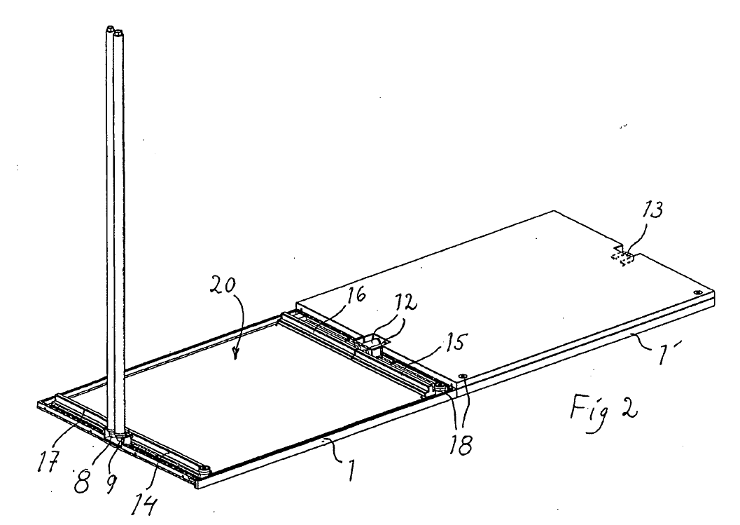

FIG. 2 shows the two interconnected cooling elements 1 and 1′ turned over with a backside plate and insulating material removed for clarity reasons.

A hose for incoming cold water is connected to the cooling medium inlet 9, preferably over a quick-coupling in order to easily achieve a sealed connection between these parts. Cooling medium entering the inlet 9 is transmitted over a distribution channel 14 over a first (lower) half of the cooling channel means 20 to a collecting channel 15 for further transmission over a connection tube portion 12 (the lower one in FIG. 2) for further transmission through a lower part of the next cooling element 1′, further over a U-shaped inter-connector pipe 13 through an upper part of the next cooling element 1′ through the other connection tube portion 12 (the upper one in FIG. 2) into another distribution channel 16 through the second half comprising the upper part of the cooling channel means 20, further into a collecting channel 17 and finally through the outlet 8 for further transmission to a cooler, to a discharge or the like.

Each distribution channel and collecting channel may be constructed substantially in the same manner as will be described below, but they can also be constructed differently.

In FIG. 2 are also shown discharge openings 18 for condensed water, which are through-going from the collecting groove 10 shown in FIG. 1. These discharge openings are preferably connectable to a discharge hose or the like for leading condensed water to a suitable location.

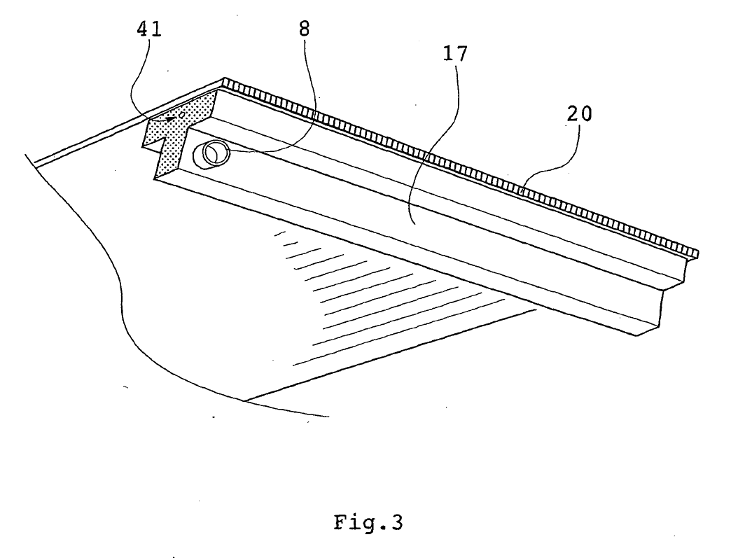

FIG. 3 shows, as an example, the collecting channel 17 being connected to the cooling channel means 20. These elements could be fixed together with double adhesive tape, glue or by any other suitable means.

In FIG. 4 the distribution channel 14 is shown having a one long or a series of shorter distribution slots 21 that distribute cooling medium from the inlet 9 to the cooling channel means. As to the element 17, the collecting channel 17, a slot or a series of equally configured slots are provided for receiving cooling medium that has already passed through cooling channel means.

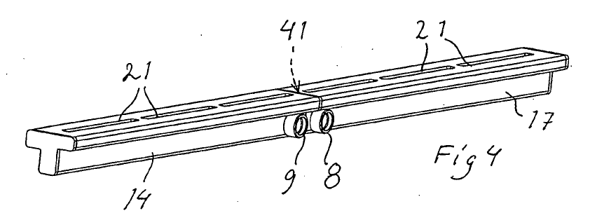

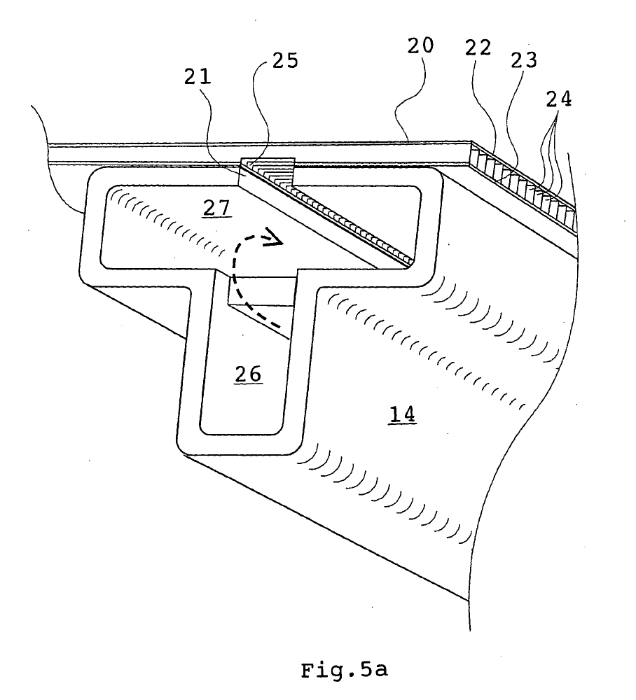

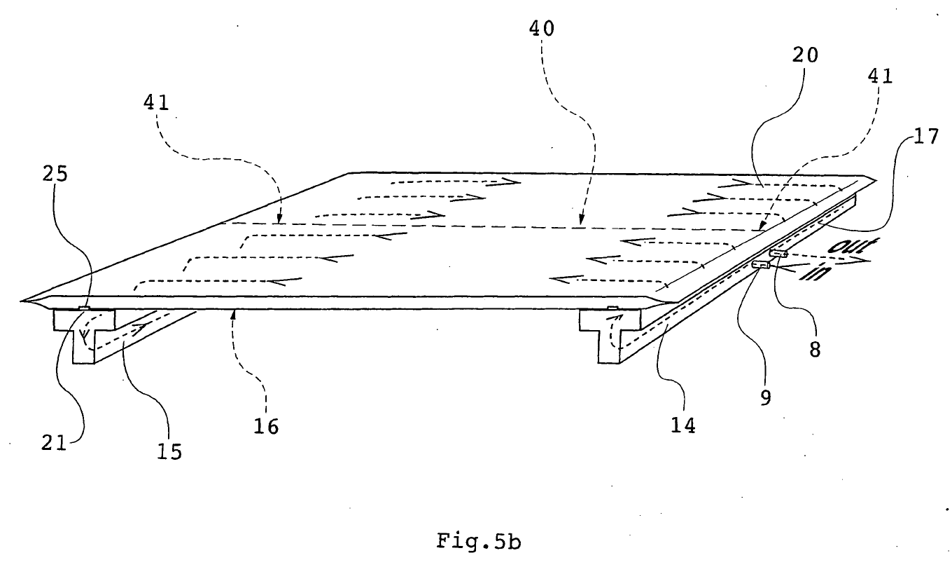

In FIG. 5a these elements are shown in more detail with the distribution channel 14, which includes a first transmission channel 26 that is connected over an aperture (indicated with interrupted line: arrow A) in a position which is intended to be at a lower position of the cooling element in its use, to a second transmission chamber 27 constituting a second part of the distribution channel which thus receives cooling medium from a lower level. Cooling medium then flows through the distribution slot or slots 21 and enters parallel channels 28 through a cut-out 25 formed in the cooling channel means, which in this preferred embodiment is comprised of channelled plastic board. A plurality of wall strips 24 together with board surface layers 22 and 23 form a corresponding plurality of channels.

This board thus includes two parallel board surface layers 22 and 23 which are spaced apart and interconnected over a plurality of parallel wall strips 24 that together form the plurality of parallel channels 28 that transmit cooling medium over the width of the cooling element. In particular, and which is preferred, the cut-out 25 is made sideways in the channelled board by cutting away a strip, corresponding to the slot 21, of the one plastic layer 23 which is in contact with the element forming the second part of the distribution channel. It should be noted that the preferred embodiment envisages that the word “width” not necessarily means the entire width, which will be clear from the description of FIG. 5b.

In FIG. 5b only the elements defining the flow path through the panel are shown in a simplified and partly exaggerated representation for better understanding of this aspect of the invention. As indicated, cooling medium such as preferably water is let in through inlet 9, transmitted to the lower part of the distribution channel 14, over the half of the cooling channel means 20 under (as seen in FIG. 5b) the interrupted line 40, which indicates the division between the two halves. Further to the collecting channel 15 for further transmission over a U-shaped inter-connector pipe (13 in FIG. 2) through the other distribution channel 16, through the second half comprising the upper part of the cooling channel means 20 (above line 40), further into the collecting channel 17 and finally through the outlet 8. The arrangement with the separation of the panel in two halves, one on either side of line 40, for flow in opposite directions is advantageous since it allows for having the inlet and outlet on the same side.

Further, one very important aspect of the invention is the provision of means for making the panel self ventilating upon upstart of the cooling plate, i.e. when it is empty from water or at least is not completely filled with water. The cooling medium is thus directed at a generally low position of the cooling channel means, because of the provision of the aperture between the first transmission channel 26 over the aperture (arrow A in FIG. 5a) to the second transmission chamber 27. Water will thus fill the cooling channel means from one side which normally is a lower positioned side.

In order to allow air to escape without being trapped inside the collecting channels, or for that matter the distribution channels and the cooling channel means, one measure is to provide a venting hole or air bleeding hole 41 (FIG. 3; Positions indicated also in FIGS. 4 and 5b) in a wall separating one distribution channel from one collecting channel. The hole 41 is made with such dimensions that air will pass relatively easy, whereas water will meet such flow resistance that there is no risk of the cooling plate suffering from short-circuiting. It is also possible to control the flow for self ventilating purposes by adjusting the flow area of the cooling channels to the flow parameters in such a way that air is prevented from being trapped inside the cooling plate, which would result in inferior cooling effect.

The ends of the channelled board are sealed in a suitable manner. One efficient way of sealing is indicated in FIG. 9, wherein is shown that the board 20 is simply provided with a heat seal 49 by heat-pressing together the edge portion with the aid of heat pressing shoes 50.

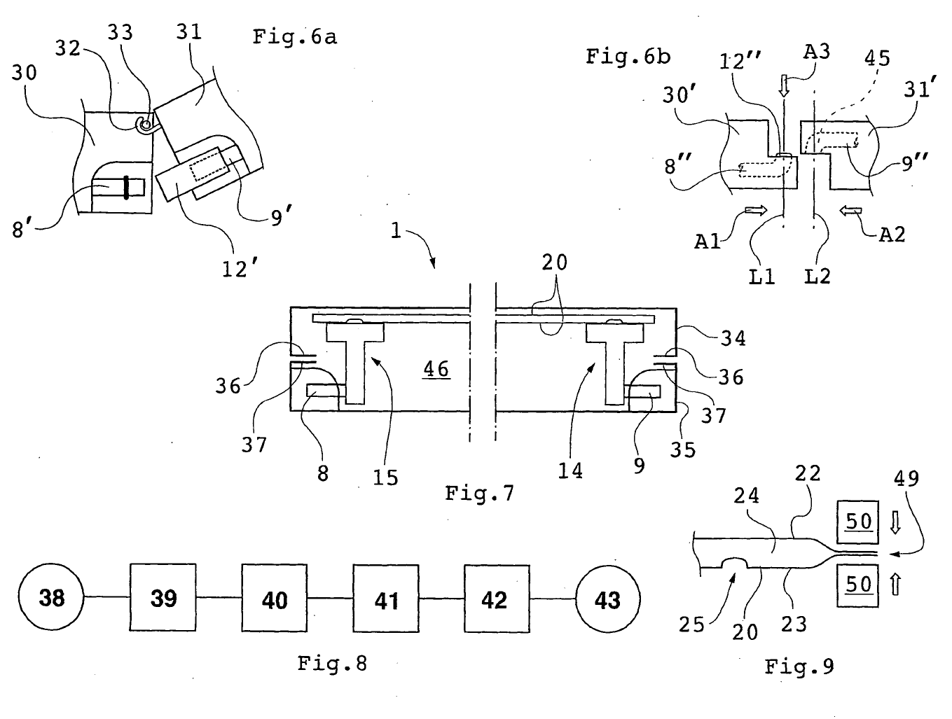

In FIG. 6a is indicated a first alternative method of interconnecting two cooling elements 30 and 31 with each other. The element 31 is fitted with means for fastening in the form of hook elements (one indicated with 32) along a transversal edge. The other element 30 is fitted with means for fastening in the form of mating pivot pins (one indicated with 33) that are engaged by the hook elements when the cooling elements 30 and 31 are hooked together while forming an angle relative to each other. Then the elements are pivoted relative to each other so as to be aligned. Hereby sealed connection will occur also between inlets (one shown at 8′) and outlets (one shown at 9′) over tube portions 12′.

In FIG. 6b is indicated a second alternative method of interconnecting two cooling elements 30′ and 31′ with each other. Fastening together can be achieved through fasteners such as e.g. screws, pins or the like (not shown) extending along axes L1-L2, which coincide when the cooling elements are properly assembled. This is achieved by bringing them together according to arrows A1-A3 and ensuring that tube portions 12″ (one shown) extending upwardly in one element sealingly enter seats 45 in the other element. Then the elements are interconnected to each other also with respect of sealed connections between inlets (one shown at 8″) and outlets (one shown at 9″) over tube portions 12″.

FIG. 7 shows a section through a cooling element 1 according to the invention, wherein a first, upper, panel half 34 connects to a second, lower, panel half 35 over surrounding strip portions 36 and 37 that extend towards the inside of the cooling element. Isolating material of the expanded cellular type that is injected into the inside 46 of the cooling element 1 will, upon expansion and hardening, press the board 20 against the upper half 34, subject the strip portions 36 and 37 to a clamping effect and thereby securely hold together the halves and ensure the integrity of the cooling element.

In FIG. 8 a sequence for the production of a cooling element according to the invention is indicated.

Position 38 is the start of the sequence.

In position 39 one first panel half, defining the cooling side is on an inside provided with a cooling channel board, preferably a channelled plastic board having cut-outs for leading cooling medium into and out from a plurality of parallel cooling conduits,
In position 40 distribution channel means for distributing and collecting cooling medium to and from the cooling channel means are positioned and fixed to the cooling channel means preferably by taping with double adhesive tape, gluing or the like,
In position 41 one second panel half defining the backside is laid to contact the first panel half over strip portions,
In position 42 thermal isolating, expanding material is supplied to the interior of the cooling element and brought to harden while the panel 1 is preferably positioned between two pressing plates in order to avoid deformation of the panel 1 during expansion of the isolating material.

Position 43 is the end of the sequence.

Other means of fixing the halves to each other are of course possible, although not considered as rational.

The invention gives the possibility of having rational modular cooling plates for displaying perishable material, the plates being easy to provide in various different sizes depending on the width of the respective modules formed by the cooling elements. They are easily connected and disconnected and in a preferred embodiment, connection of two cooling elements also at the same time provides interconnection of channels for cooling medium.

As a termination of a set of cooling elements there are provided end plates, which are fastened to a transversal edge side which is at the end of the set. Such a plate is positioned in such a way that it fixes in position the U-shaped inter-connector pipe 13 indicated in FIG. 2 as well as a hose h which is connected to an inlet 9 and an outlet 8 (only one hose h shown). Other ways of terminating the set are possible.

The cooling element according to the invention is preferably manufactured from plates of aluminium or an alloy thereof even if also other materials may come into question. The cooling channel means are, as indicated above, preferably made from a standard plastic component. These cooling channel means have to be sealed at their longitudinal ends and this is readily made in various ways such as providing sealing strips or the like. In case of channelled plastic board, sealing can simply be made by heat-pressing together the two spaced apart layers so as to obtain a sealed seam (FIG. 9). Connecting tube portions 12, 12′ can be constructed so as to be sealingly inserted inside inlet/outlet holes.

The isolating material is preferably one of many expandable, hardening cellular plastics such as expanded polyurethane.

1. Cooling element (1) for cooling of products such as foodstuffs, said cooling element having essentially panel shape with a cooling side (2), a backside (3), a pair of transversal edge sides (4,4′) and a pair of longitudinal edge sides (5,5′), and having an inlet (9) and an outlet (8) for cooling medium to be transmitted through cooling channel means (20), characterized in—that the cooling element (1) is provided with means (6,7) for fastening it together with another similar cooling element (1′) at least on one transversal edge side.

2. Cooling element according to claim 1, characterized in that the means (6,7) for fastening are controllable from the cooling side (2) between a locking position and a releasing position.

3. Cooling element (1) according to claim 1, characterized in that at least one of the inlet (9) and the outlet (8) for cooling medium is positioned in the region of said one transversal edge side so that it is connectable to an outlet or an inlet respectively of said another similar cooling element (1′) through a relative displacement movement between the two elements involved.

4. Cooling element (1) according to claim 1, 2 or 3, characterized in that each inlet (9) and outlet (8) for cooling medium is sealingly connectable with a first end part of a complementary tube portion (12) which is sealingly connectable with a second end part with an outlet or an inlet respectively of said another similar cooling element (1′).

5. Cooling element according to claim 1, characterized in that each inlet and outlet for cooling medium is positioned inside a recess formed in said one transversal edge side.

6. Cooling element according to claim 1, characterized in that the inlet (9) and the outlet (8) for cooling medium are positioned essentially centrally on the transversal edge side.

7. Cooling element according to claim 1, characterized in that the inlet leads to a distribution channel (14) for distributing cooling medium to the cooling channel means (20).

8. Cooling element according to claim 1, characterized in that the cooling channel means (20) includes a plurality of parallel conduits (28) that extend side by side from one edge side of the cooling element to the other.

9. Cooling element according to claim 8, characterized in that the conduits (28) are formed in one integral constructional unit (20).

10. Cooling element according to claim 8, characterized in that said constructional unit (20) is comprised of a channel board, preferably a channelled plastic board.

11. Cooling element according to claim 8, characterized in that the inlet leads to a distribution channel (14) for distributing cooling medium to the cooling channel means (20), and the distribution channel (14) connects to the parallel conduits (28) of said cooling channel means over a cut-out or cut-outs (25) in an element or elements forming the cooling channel means.

12. Cooling element according to claim 8, characterized in that the inlet leads to a distribution channel (14) for distributing cooling medium to the cooling channel means (20), and the distribution channel (14) has its intake for cooling medium close to a longitudinal side of the cooling element intended to be in a low position in operation.

13. Cooling element according to claim 1, characterized in that it is provided with a sealing strip (19) on each transversal side.

14. Cooling element according to claim 13, characterized in that
each said sealing strip (19) is positioned in a groove.

15. Cooling element according to claim 1, characterized in that it is provided with a collecting groove (10) for condensed liquid or the like.

16. Cooling element according to claim 15, characterized in that
the collecting groove (10) is partly defined by an edge strip (11) extending above a general plane of a cooling side face (2).

17. Cooling element according to claim 1, characterized in that the inlet (9) and the outlet (8) are located on one and the same side and that the cooling channel means (20) is divided (41) into two halves for flow in opposite directions between two sides of the cooling element.

18. Cooling element according to claim 17, characterized in that the inlet leads to a distribution channel (14) for distributing cooling medium to the cooling channel means (20) and an air ventilating hole (41) is arranged between a collecting channel (15; 17) for cooling medium associated with the cooling channel means (20) and the distribution cannel (14; 16).

19. Cooling element (1) for cooling of products such as foodstuffs, said cooling element having essentially panel shape with a cooling side (2), a backside (3), a pair of transversal edge sides (4,4′) and a pair of longitudinal edge sides (5,5′), and having an inlet (9) and an outlet (8) for cooling medium to be transmitted through cooling channel means (20), characterized in that the cooling channel means (20) includes a plurality of parallel conduits (28) that extend side by side from one edge side of the cooling element to the other, and that the conduits (28) are formed in one integral constructional unit (20).

20. Cooling element according to claim 19, characterized in that the inlet leads to a distribution channel (14) for distributing cooling medium to the cooling channel means (20).

21. Cooling element according to claim 19, characterized in that said constructional unit (20) is comprised of a channel board, preferably a channeled plastic board, having a plurality of wall strips (24) which together with two parallel board surface layers (22 and 23) form a corresponding plurality of channels.

22. Cooling element according to claim 20, characterized in that the distribution channel (14) connects to the parallel conduits (28) of said cooling channel means over a cut-out or cut-outs (25) in an element or elements forming the cooling channel means.

23. Cooling element according to claim 20, characterized in that the distribution channel (14) has its intake for cooling medium close to a longitudinal side of the cooling element intended to be in a low position in operation of an inclined cooling element.

24. Cooling element according to claim 19, characterized in that the inlet leads to a distribution channel (14) for distributing cooling medium to the cooling channel means (20), and the inlet (9) and the outlet (8) are located on one and the same side and that the cooling channel means (20) is divided (41) into two halves for flow in opposite directions between two sides of the cooling element.

25. Cooling element according to claim 24, characterized in that the inlet leads to a distribution channel (14) for distributing cooling medium to the cooling channel means (20), and an air ventilating hole (41) is arranged between a collecting channel (15; 17) for cooling medium associated with the cooling channel means (20) and the distribution channel (14; 16).

26. Cooling element (1) for cooling of products such as foodstuffs, said cooling element having essentially panel shape with a cooling side (2), a backside (3), a pair of transversal edge sides (4,4′) and a pair of longitudinal edge sides (5,5′), and having an inlet (9) and an outlet (8) for cooling medium to be transmitted through cooling channel means (20), characterized in
that one first panel half, defining the cooling side (2) is on an inside provided with a cooling channel means (20),
that one second panel half defining the backside (3) contacts the first panel half in edge regions, and
that thermal isolating material is provided in the interior of the cooling element (1) between the channel means and the inside of the second panel half.

27. Cooling element according to claim 26, wherein the cooling channel means (20) includes a cooling channel board (20).

28. Cooling element according to claim 26, wherein distribution channel means (14, 15, 16, 17) are arranged for distributing and collecting cooling medium to and from the cooling channel means.

29. Cooling element according to claim 26, wherein the panel halves contact each other over strip portions on both panel halves.

30. Cooling element according to claim 26, wherein the isolation material provides a clamping action to the contacting strip portions and thereby to the panel halves.

31. Cooling element according to claim 26, wherein it is provided with means (6,7.) for fastening it together with another similar cooling element (1′) at least on one transversal edge side.

32. Cooling element according to claim 31, characterized in that the means (6,7) for fastening are controllable from the cooling side (2) between a locking position and a releasing position.

33. Cooling element (1) according to claim 26, characterized in that at least one of the inlet (9) and the outlet (8) for cooling medium is positioned in said one transversal edge side so that it can be connected to an outlet or an inlet respectively of said another similar cooling element (1′).

34. Cooling element (1) according to claim 26, characterized in that each inlet (9) and outlet (8) for cooling medium is connectable with a first end part of a complementary tube portion (12) which is connectable with a second end part with an outlet or an inlet respectively of said another similar cooling element (1′).

35. Cooling element according to claim 26 characterized in that each inlet and outlet for cooling medium is positioned inside a recess formed in said one transversal edge side.

36. Cooling element according to claim 26, characterized in that the inlet (9) and the outlet (8) for cooling medium are positioned essentially centrally on the transversal edge side.

37. Cooling element according to claim 26, characterized in that the inlet leads to a distribution channel (14) for distributing cooling medium to the cooling channel means (20).

38. Cooling element according to claim 26, characterized in that the cooling channel means (20) includes a plurality of parallel conduits (28) that extend side by side from one edge side of the cooling element to the other.

39. Cooling element according to claim 38, characterized in that
the conduits (28) are formed in one integral constructional unit (20).

40. Cooling element according to claim 38, characterized in that said constructional unit (20) is comprised of a channel board, preferably a channeled plastic board.

41. Cooling element according to claim 40, characterized in that the inlet leads to a distribution channel (14) for distributing cooling medium to the cooling channel means (20), and the distribution channel (14) connects to the parallel conduits (28) of said cooling channel means over a cut-out or cut-outs (25) in an element or elements forming the cooling channel means.

42. Cooling element according to claim 38, characterized in that the inlet leads to a distribution channel (14) for distributing cooling medium to the cooling channel means (20), and the distribution channel (14) has its intake for cooling medium close to a longitudinal side of the cooling element intended to be in a low position in operation.

43. Cooling element according to claim 26, characterized in that it is provided with a sealing strip (19) on each transversal side.

44. Cooling element according to claim 43, characterized in that each said sealing strip (19) is positioned in a groove.

45. Cooling element according to claim 26, characterized in that it is provided with a collecting groove (10) for condensed liquid or the like.

46. Cooling element according to claim 45, characterized in that the collecting groove (10) is partly defined by an edge strip (11) extending above a general plane of a cooling side face (2).

47. Cooling element according to claim 26, characterized in that the inlet (9) and the outlet (8) are located on one and the same side and that the cooling channel means (20) is divided (41) into two halves for flow in opposite directions between two sides of the cooling element.

48. Cooling element according to claim 47, characterized in that the inlet leads to a distribution channel (14) for distributing cooling medium to the cooling channel means (20) and an air ventilating hole (41) is arranged between a collecting channel (15; 17) for cooling medium associated with the cooling channel means (20) and the distribution channel (14; 16).

49. Method of producing a cooling element (1) having essentially panel shape with a cooling side (2), a backside (3), a pair of transversal edge sides (4,4′) and a pair of longitudinal edge sides (5,5′), and having an inlet (9) and an outlet (8) for cooling medium to be transmitted through cooling channel means, wherein
one first panel half, defining the cooling side (2) is on an inside provided with a cooling channel means (20),
distribution channel means (14, 15, 16, 17) for distributing and collecting cooling medium to and from the cooling channel means are positioned so as to contact the cooling channel means,
one second panel half defining the backside (3) is laid to contact the first panel half, and
thermal isolating material is supplied to the interior of the cooling element (1).

50. Method according to claim 49, wherein the panel halves are brought into contact over strip portions on both panel halves.

51. Method according to claim 50, wherein the isolation material is supplied such that it provides a clamping action to the contacting strip portions and thereby to the panel halves.

52. System for cooling of products such as foodstuffs in stores or the like and including a stand, at least one cooling element and cooling medium transmission means, characterized in that it includes at least one cooling element according to claim 1.
